(19) United States
(12) Patent Application Publication
(10) Pub. No.: US 2024/0106062 A1
(43) Pub. Date: Mar. 28, 2024

(54) BATTERY PACKS WITH RIGIDIZING BRACKETS

(71) Applicant: Apple Inc., Cupertino, CA (US)

(72) Inventors: Dylan Erb, San Jose, CA (US); Nivay Anandarajah, San Leandro, CA (US); Alexander Bartlett, San Jose, CA (US); Abraham B. Caulk, Livermore, CA (US); Edward T. Hillstrom, Vancouver (CA); Evan D. Maley, Redwood City, CA (US); Erik C. Ostergaard, Asheville, NC (US); Matthew I. Woods, Los Gatos, CA (US)

(21) Appl. No.: 18/104,285

(22) Filed: Jan. 31, 2023

Related U.S. Application Data
(60) Provisional application No. 63/376,885, filed on Sep. 23, 2022.

(51) Int. Cl. H01M 50/291; H01M 10/058; H01M 50/209; H01M 50/271

(52) U.S. Cl. CPC H01M 50/291; H01M 10/058; H01M 50/209; H01M 50/271; H01M 10/0525

(57) ABSTRACT

A battery pack can include a plurality of battery cells arranged adjacent one another in a row. The battery pack can include a first spacer plate aligned with and positioned adjacent the first cell of the plurality of battery cells, a second spacer plate aligned with and positioned adjacent the last cell of the plurality of battery cells, and a housing enclosing the plurality of battery cells. The housing can include a first sidewall positioned adjacent the first spacer plate and a second sidewall positioned adjacent the second spacer plate such that the plurality of battery cells can be positioned between the first sidewall and the second sidewall. The battery pack can include a cover. A layer of adhesive can be disposed between the battery cells and the cover. Various techniques can be employed to improve the durability of the battery pack.

### CROSS-REFERENCES TO RELATED APPLICATIONS

This application claims the benefit of U.S. Provisional Patent Application Ser. No. 63/376,885, filed Sep. 23, 2022, for “BATTERY PACKS WITH RIGIDIZING BRACKETS,” the entire disclosure of which is hereby incorporated by reference for all purposes

### CROSS-REFERENCES TO OTHER APPLICATIONS

This application is related to the following U.S. provisional patent applications: U.S. Provisional Patent Application Ser. No. 63/376,862, for “STRUCTURAL BATTERY PACK WITH DURABILITY IMPROVEMENTS,” filed on Sep. 23, 2022; U.S. Provisional Patent Application Ser. No. 63/376,901, for “BATTERY PACKS WITH RIGIDIZED HOUSING FEATURES,” filed on Sep. 23, 2022, each of which is hereby incorporated by reference in its entirety for all purposes.

### BACKGROUND OF THE INVENTION

In general, conventional vehicle battery packs can use modules that are bolted into a structural housing and then covered with a lid. The use of modules can ease assembly of the battery packs and can improve the serviceability of the individual cells. In these packs, the cells are not considered structural members of the pack.

Structural battery packs can harness the stiffness of the battery cells that they contain to increase the stiffness of the overall pack and therefore reduce the overall mass and/or volume of the pack. To achieve this, the cells can be bonded with adhesives to the pack housing at the cost of cell serviceability. Battery cells can be designed and manufactured for energy density reasons. Therefore, the housings for the battery cells can be extremely thin. For example, the cells can be manufactured using thin (e.g., 0.3 millimeters thick) aluminum. In other cases, the battery cells can be wrapped in a polyethylene terephthalate (PET) wrap. Reliability issues can develop due to the adhesive pulling cells open in high stress areas (e.g., at a weld joint that is proximate an edge of the battery pack).

Prismatic and cylindrical cells can require welds at certain locations to seal the cells. These welds can crease regions where the mechanical strength of the base material can be significantly reduced.

If stress concentrations that originate from mechanical shock and vibration are located near welds or other sensitive areas on the cell, mechanical failure of the battery cell can result. Mechanical failure can lead to electrolyte leaks and loss of high voltage isolation. One vulnerable region can be the edges of the battery cells near the perimeter of the battery housing.

### BRIEF SUMMARY OF THE INVENTION

Various techniques can be employed to improve the durability of the battery pack, reducing the potential for battery failure.

In some embodiments a battery pack comprises a plurality of battery cells arranged adjacent one another in a row extending from a first cell in the row to a last cell in the row. A housing encloses the plurality of battery cells, the housing including: a first sidewall positioned adjacent the first cell, a second sidewall positioned adjacent a second cell such that the plurality of battery cells are positioned between the first sidewall and the second sidewall, first and second lateral walls extending between the first and second sidewalls and a cover positioned across the plurality of battery cells and extending from the first sidewall to the second sidewall. A layer of adhesive is disposed between the plurality of battery cells and the cover. A bracket includes a first portion attached along a top surface of the first cell and a second portion attached along a portion of a wall of the first cell, wherein the bracket extends along a width of the first cell.

In some embodiments the bracket extends along a width of each of the plurality of battery cells. In various embodiments the bracket is positioned parallel to the first lateral wall and extends along at least a portion of a length of the first lateral wall. In some embodiments the battery pack further comprises a base positioned opposite the cover and extending between the first and the second sidewalls. In various embodiments each of the plurality of battery cells are attached to the base. In some embodiments the bracket is a first bracket and the battery pack comprises a second bracket that is attached along a bottom surface of the first cell and along a portion of the wall of the first cell. In various embodiments the bracket is an L-shaped bracket.

In some embodiments a battery pack comprises a plurality of battery cells arranged adjacent one another in a row extending from a first cell in the row to a last cell in the row. A housing encloses the plurality of battery cells, the housing including: a first sidewall positioned opposite a second sidewall, first and second lateral walls that extend between first and second sidewalls, a cover positioned across the plurality of battery cells and extending from the first sidewall to the second sidewall and from the first lateral wall to the second lateral wall. A layer of adhesive is disposed between the plurality of battery cells and the cover. A bracket attached to the row of battery cells and to the cover.

In some embodiments the bracket extends along a length of the row of battery cells and is attached to each battery cell of the row of battery cells. In various embodiments the bracket has a first portion that is attached to the cover and a second portion that is attached to a wall of each battery cell of the row of battery cells. In some embodiments the bracket includes a stiffener extending between the first portion of the bracket and the second portion of the bracket. In various embodiments the bracket is a first bracket, and the battery pack further comprises a second bracket attached to each cell of the row of battery cells and to a base that is opposite the cover. In some embodiments the bracket is an L-shaped bracket. In various embodiments the bracket is attached to the first cell and to the cover with an adhesive.

In some embodiments a method for forming a battery pack, comprises arranging a plurality of battery cells adjacent one another in a row extending from a first cell in the row to a last cell in the row and enclosing the plurality of battery cells in a housing. The housing includes: a first sidewall positioned opposite a second sidewall, first and second lateral walls extending between the first and the second sidewalls and a cover positioned across the plurality of battery cells and extending from the first sidewall to the second sidewall. A bracket is attached along an edge of the row of battery cells and a layer of adhesive is disposed between the row of battery cells and the cover.

In some embodiments the bracket extends along a length of the row of battery cells and is attached to each battery cell of the row of battery cells. In various embodiments the bracket has a first portion that is attached to the cover and a second portion that is attached to a wall of each battery cell of the row of battery cells. In some embodiments the bracket has a first portion that is attached to the cover and a second portion that is attached to a wall of each battery cell of the row of battery cells. In various embodiments the bracket is an L-shaped bracket with the first portion oriented perpendicular to the second portion. In some embodiments the housing further comprises a base that is attached to the plurality of battery cells.

### BRIEF DESCRIPTION OF THE DRAWINGS

FIG. 1 illustrates a simplified perspective view of a battery pack according to embodiments of the disclosure;

FIG. 2 illustrates a close-up partial cross-sectional view of a corner of a cell stack of the structural battery pack of FIG. 1 with a void formed in an adhesive layer;

FIG. 3 illustrates a comparison of stress values between a baseline structural battery pack and a battery pack with a void formed in an adhesive layer;

FIG. 4 illustrates a method of forming a battery pack with a void in an adhesive layer, according to embodiments of the disclosure;

FIG. 5 illustrates a close-up partial cross-sectional view of a corner of a battery pack that has an increased bond line thickness, according to embodiments of the disclosure;

FIG. 6 illustrates a close-up partial cross-sectional view of a corner of a battery pack that has a cover with an increased thickness, according to embodiments of the disclosure;

FIG. 7 illustrates a method of forming a battery pack that includes an increased bond line thickness, according to embodiments of the disclosure;

FIG. 8 illustrates a close-up partial cross-sectional view of a corner of a battery pack that has a bracket attached to the battery cells, according to embodiments of the disclosure;

FIG. 9 illustrates a close-up partial cross-sectional view of a corner of a battery pack that has a bracket attached to the battery cells and to the battery pack cover, according to embodiments of the disclosure;

FIG. 10 illustrates a close-up partial cross-sectional view of a corner of a battery pack that has adhesive attaching a sidewall of the battery pack housing to the battery cells, according to embodiments of the disclosure;

FIG. 11 illustrates a close-up partial cross-sectional view of an interior face of a battery stack within a battery pack, according to embodiments of the disclosure;

FIG. 12 illustrates a method of forming a battery pack that includes a bracket attached to the battery cells, according to embodiments of the disclosure; and

FIG. 13 illustrates a perspective view of a battery pack that employs bond line limiters, according to embodiments of the disclosure.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Battery packs may include any number of battery cells packaged together to produce an amount of power. For example, many rechargeable batteries may include multiple cells having any number of designs including wound, stacked, prismatic, as well as other configurations. The individual cells may be coupled together in a variety of ways including series connections and parallel connections. As increased capacity is sought from smaller form factors, battery cell configurations and packaging may play an important role in operation of the battery system under normal operating conditions as well as during abuse conditions.

For example, cell damage may lead to short circuiting in some battery cell designs, which may cause temperature increases initiating exothermic reactions leading to thermal runaway. These events may generate temperatures of several hundred degrees over a period of time that may be seconds, minutes, or more depending on the size and capacity of the cell.

Conventional packs have attempted to control failure spread of this nature by isolating cells, incorporating extensive insulation, or increasing the separation of cells from one another. Although these features may provide additional protection from cell failure spreading to adjacent cells, this may also limit capacity of a battery pack below some system requirements. Additionally, when battery packs are used in devices that may be dropped, impacted, pierced, or otherwise damaged, the battery pack and constituent cells may also be damaged, which may cause similar exothermic reactions to occur. Consequently, conventional technologies may further insulate and isolate the battery cells from a housing or structural support, which may further reduce capacity or energy density of the battery pack. The present technology overcomes these issues by creating systems that structurally integrate the battery cells within the battery housing to facilitate load distribution for different abuse events. By integrating the battery cells directly into the overall pack structure, housing components may be reduced, which may allow increased volumetric density and specific energy for the battery pack, which may provide a more compact and robust design compared to conventional systems.

Advantageously, by reducing the stress applied from the battery pack housing to the battery cells, the present technology may improve the reliability of the battery pack. In some embodiments the stress is reduced by forming a recess in an adhesive layer that couples the battery pack housing to the battery cells to reduce stress applied to the outer edge of the battery cells. In various embodiments a cover of the housing may include a recess that enables the layer of adhesive to have an increased thickness at the outer edge of the battery cells while in various embodiments the cover may have an increased cross-section and therefore increased rigidity at the outer edge of the battery cells. In some embodiments an L-shaped bracket may be attached along one or more outer edges of the battery cells in the battery pack to decrease stresses applied to the outer edges of the battery cells. These and various other embodiments to reduce stresses applied to the battery cells from the battery pack housing are described herein.

Although the remaining portions of the description will routinely reference lithium-ion or other rechargeable batteries, it will be readily understood by the skilled artisan that the technology is not so limited. The present techniques may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air-travel equipment, and space-travel equipment, as well as any other device that may use batteries or benefit from the discussed designs. Accordingly, the disclosure and claims are not to be considered limited to any particular example discussed, but can be utilized broadly with any number of devices that may exhibit some or all of the electrical or other characteristics of the discussed examples.

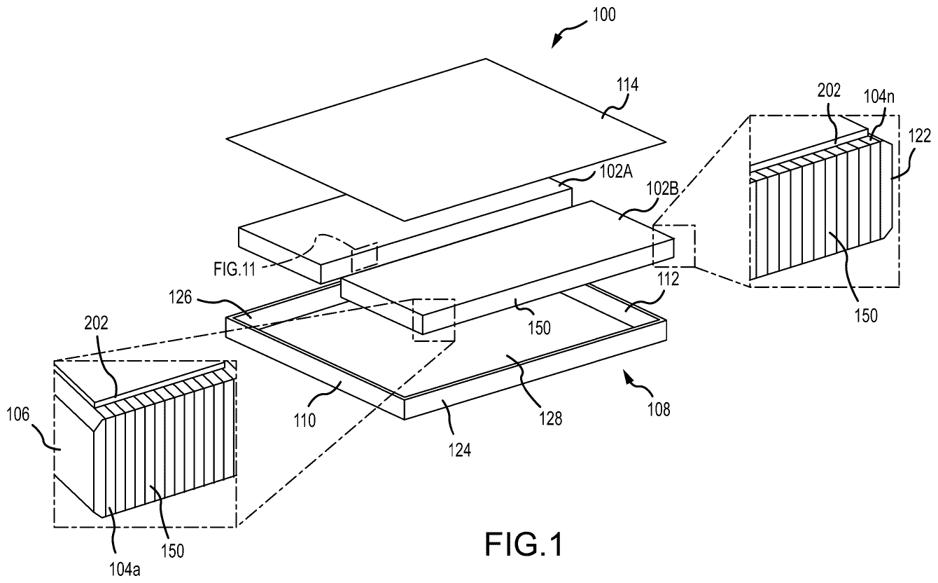

FIG. 1 illustrates a simplified perspective view of a structural battery pack 100. As shown in FIG. 1, a battery pack 100 can include one or more battery stacks 102 (e.g., 102A and 102B) each comprising a plurality of lithium-ion battery cells 104 arranged adjacent one another in a row extending from a first cell 104a in the row to a last cell 104n in the row.

In various embodiments the battery pack 100 can be an energy storage pack. The battery pack 100 can include a first spacer plate 106 aligned with and positioned adjacent the first cell 104a of the plurality of battery cells and a second spacer plate 122 aligned with and positioned adjacent the last cell 104n of the plurality of battery cells. In some embodiments first and second spacer plates 106, 122, respectively, can be used to compress the row of cells before disposing them within a housing, described in more detail below.

The battery pack 100 can include a housing 108 enclosing the plurality of battery cells 104. The housing 108 can include a first sidewall 110 positioned adjacent the first spacer plate 106. The housing 108 can include a second sidewall 112 positioned adjacent the second spacer plate 122 such that the plurality of battery cells can be positioned between the first sidewall 110 and the second sidewall 112. The housing 108 can further include first and second lateral walls 124, 126, respectively, that extend between first and second sidewalls 110, 112, respectively.

The housing 108 can include a cover 114 opposite a base 128, that are each positioned across the plurality of battery cells 104 and extend from the first sidewall 110 to the second sidewall 112 and from the first lateral wall 124 to the second lateral wall 126. In various embodiments, the cover 114 and/or the base 128 can have a relatively high thermal conductivity and may be made from, e.g., aluminum, so they can function as heat exchangers. The battery pack 100 can include a first layer of adhesive 202 disposed between the plurality of battery cells 104 and the cover 114, and in some embodiments can additionally or alternatively include a second layer of adhesive (not shown in FIG. 1) disposed between the plurality of battery cells 104 and the base 128.

As further shown in FIG. 1, a front face 150 of stack 102B may be defined by the row of battery cells 104. Front face 150 may be positioned parallel and adjacent to first lateral wall 124 with a gap defined therebetween. A similar face (not shown in FIG. 1) may be defined by the row of battery cells in stack 102A and may be positioned parallel and adjacent to second lateral wall 126. The layer of adhesive 202 is recessed from the front face 150 defining a void in the layer of adhesive where the void crosses each battery cell and extends along first lateral wall 124, as described in more detail below. In some embodiments the void may extend along at least a portion of first lateral wall 124. As discussed above a second layer of adhesive (not shown in FIG. 1) may be disposed between based 128 and first and second stacks 102A, 102B, and a similar void may be formed adjacent to front face 150 along all or a substantial portion of first lateral wall 124. As further discussed above a similar front face may be formed between first stack 102A and second lateral wall 126. Voids in the first and second adhesive layers disposed between the first stack 102A and cover 114 and base 128 may be formed that extend along all or a substantial portion of second lateral wall 126. In some embodiments there may be four longitudinal adhesive voids formed in battery 100.

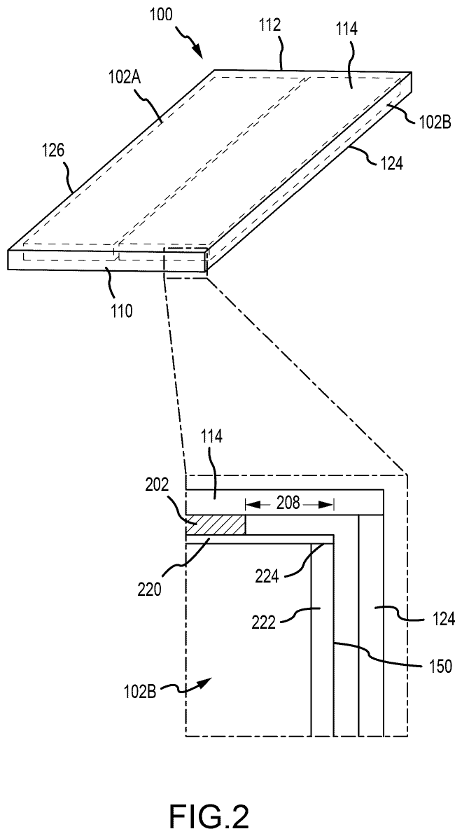

FIG. 2 illustrates a close-up partial cross-sectional view of a corner of cell stack 102B of the structural battery pack 100 of FIG. 1. Battery cell stack 102B may define a front face 150 that is positioned adjacent and parallel to first lateral wall 124. In some embodiments each of the plurality of battery cells (e.g., 104a) can have a cell enclosure that includes a cell lid 220 attached (e.g., welded) to a cell wall 222 at joint 224. In some embodiments the cell lid 220 can be relatively thin (e.g., 0.3 millimeters) and the cell wall 222 can be relatively thick (e.g., 2 millimeters) resulting in stress concentration at joint 224 during battery pack 100 deformation. Joint 224 may have reduced strength in the heat-affected zone of the welded joint.

The layer of adhesive 202 can be disposed between the plurality of battery cells 104 and the cover 114. In various embodiments, the layer of adhesive 202 can extend across each battery cell stack and may be recessed from the front face 150 of the row a width 208, defining a void in the layer of adhesive that is positioned adjacent front face 150. A second layer of adhesive (not shown in FIG. 2) can be positioned between the plurality of battery cells 104 and base 128 (see FIG. 1) and may have a similar void formed by a recess from front face 150. The technique of recessing (or pulling back) the layer of adhesive 202 from front face 150 can reduce stresses applied from housing 108 to joint 224 of each battery cell 104. More specifically, by removing layer of adhesive 202 from the region of the joint 224 the stresses applied to the joint 224 can be reduced at the outermost edge of the cells (which typically experience the highest stresses), improving the reliability of the battery pack 100. Because of the relatively short width of void 208, as compared to the overall battery pack 100 size, the mechanical stiffness of the battery pack may be minimally reduced (e.g., 1%) by the addition of the voids.

In some embodiments, first void 208 can have a width that is between 1 and 40 millimeters while in other embodiments the first void can have a width that is between 2 and 30 millimeters and in some embodiments the width is between 2 and 15 millimeters

In some embodiments, as the width 208 of the first void is increased, the stiffness of the battery pack can be decreased, while stresses applied to the battery cell 104 joints 224 can be commensurately decreased. A width 208 for the void formed in the layer of adhesive can be specific for each battery pack. The width 208 of the first void can be determined through experimentation, testing and/or analysis. An ideal point can be determined that provides the necessary stiffness for the battery pack but reduces the stress concentrated at the edge of the battery cells. The range of width 208 can be dependent on a size of the battery pack 100, an aspect ratio of the battery pack 100, and similar dimensional aspects of the battery pack 100. In various embodiments, a foam strip can be used to shut-out the adhesive at the optimum distance from the edge of the battery cells. In various embodiments, a non-structural adhesive can be applied from the edge to the optimum distance as opposed to using the foam. In some embodiments, a thermal gap filler (e.g., a material with a high thermal conductivity) can also be used from the edge of the cells to the optimum distance.

In some embodiments the adhesive 202 can be applied in various patterns. In various embodiments, the adhesive can be applied in a pattern that is transverse to a length of the battery pack 100. This pattern can reduce the adhesive flowing between the cells which can result in cracks propagating along the adhesive bead and delamination occurring in the cracks. Thus, in some embodiments a transverse pattern can minimize the amount of delamination that may occur.

In various embodiments, a foam gasket (e.g., a pressure sensitive adhesive foam gasket) can be applied to the cover 114 of the housing 108 to set a bond line thickness of the adhesive layer 202 and/or to form a width 208 of the void. In various embodiments, a form in place gasket can be used between the cover 114 and the battery stack 102. In some embodiments, there may be no gasket or foam and only a gap filled with air may be arranged between the adhesive and the cover 114.

In some embodiments, a foam gasket can act as a seal to set the adhesive line. The bond gap can be set so that a cantilevered cell does not contact the first and second spacers 106, 122, respectively, and/or lid 114 during durability loading. This technique can provide space for a secondary cap or insulative plastic part on cell ends to assist with creepage and clearance performance at the edges of the cells.

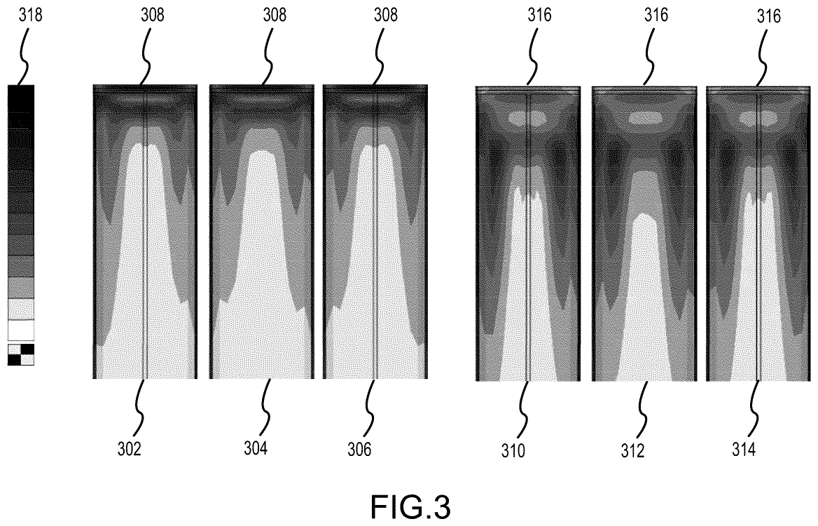

FIG. 3A illustrates a stress contour plot for a representative battery pack that may be similar to battery pack 100 described in FIGS. 1 and 2. FIG. 3A illustrates a first view 302, a second view 304 and a third view 306 of the stress contours of battery cells within a baseline battery pack having no void formed in the adhesive (e.g., a width 208 of the first void, see FIG. 2, is zero). As shown in FIG. 3A, regions of relatively high stress 308 can develop near the edges of the battery cells which may lead to premature failure of the battery cells. In some embodiments the high stresses may result in rupture of the cell enclosures where the cell lid 220 (see FIG. 2) is attached to the cell wall 222 at joint 224. A scale 318 can be used to interpret stress contours of the battery cell.

Comparatively, FIG. 3B illustrates first, second and third views, 310, 312, 314, respectively, of stress contours of battery cells within a battery pack that includes a void formed in the adhesive (e.g., a width 208 of the first void, see FIG. 2, is 2-15 millimeters). As shown in FIG. 3B, the same regions shown in FIG. 3A that had relatively high stress, are now regions of relatively lower stress 316. Thus, the introduction of a void (see FIG. 2) reduces the stress at the edge of the battery cells, improving reliability of the cells and reducing the transfer of stress from the battery pack housing 108 (see FIG. 1) to the plurality of battery cells 104.

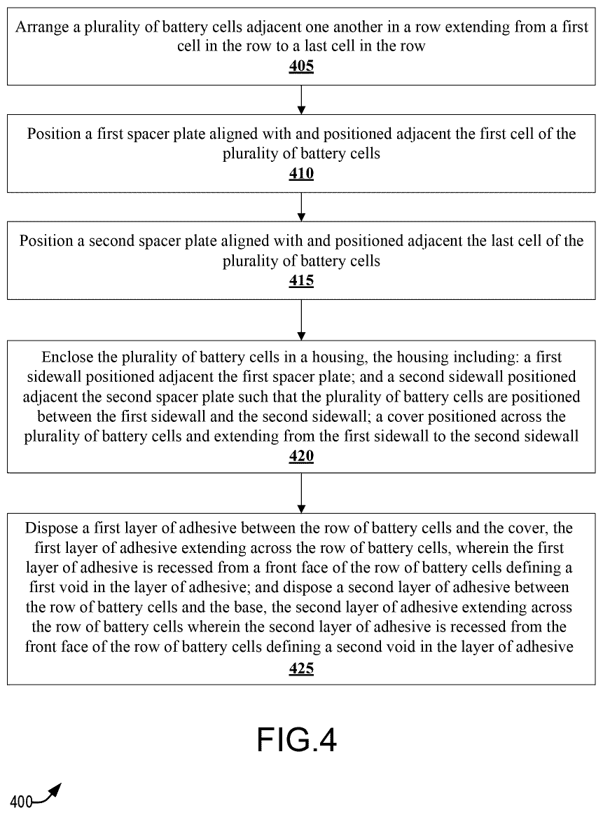

FIG. 4 is a flow chart of a process 400 for forming a battery pack, according to an example of the present disclosure. According to an example, one or more process blocks of FIG. 4 may be performed by one or more machines or via a manufacturing process.

At block 405, process 400 may include arranging a plurality of battery cells adjacent one another in a row extending from a first cell in the row to a last cell in the row. For example, one or more machines or via a manufacturing process may arrange a plurality of battery cells adjacent one another in a row extending from a first cell in the row to a last cell in the row, as described above.

At block 410, process 400 may include positioning a first spacer plate aligned with and positioned adjacent the first cell of the plurality of battery cells. For example, one or more machines or via a manufacturing process may position a first spacer plate aligned with and positioned adjacent the first cell of the plurality of battery cells, as described above.

At block 415, process 400 may include positioning a second spacer plate aligned with and positioned adjacent the last cell of the plurality of battery cells. For example, one or more machines or via a manufacturing process may position a second spacer plate aligned with and positioned adjacent the last cell of the plurality of battery cells, as described above.

At block 420, process 400 may include enclosing the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall. For example, one or more machines or via a manufacturing process may enclose the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall, as described above. In some embodiments the housing may also include a base that is opposite the cover and first and second lateral walls that extend between the first and second sidewalls. In various embodiments the housing components may be welded together at the joints and may form an integral mechanical structure with the plurality of battery cells.

At block 425, process 400 may include disposing a first layer of adhesive between the row of battery cells and the cover, the first layer of adhesive extending across the row of battery cells where the first layer of adhesive is recessed from a front face of the row of battery cells defining a first void in the layer of adhesive. Process 400 may include disposing a second layer of adhesive between the row of battery cells and the base, the second layer of adhesive extending across the row of battery cells where the second layer of adhesive is recessed from the front face of the row of battery cells defining a second void in the layer of adhesive. In some embodiments the row of battery cells are adhered to both the cover and the base forming an integral mechanical structure. In some embodiments a second battery pack may be disposed within the housing and may have similar upper and lower voids.

Process 400 may include additional implementations, such as any single implementation or any combination of implementations described below and/or in connection with one or more other processes described elsewhere herein. In a first implementation, the adhesive may include a thermal adhesive.

In various embodiments, process 400 may include isolating portions of the plurality of battery cells from the housing using insulating material. In some embodiments, process 400 may include disposing one or more form-in-place foam gaskets on one or more weaker cell weld regions of the plurality of battery cells.

It should be noted that while FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

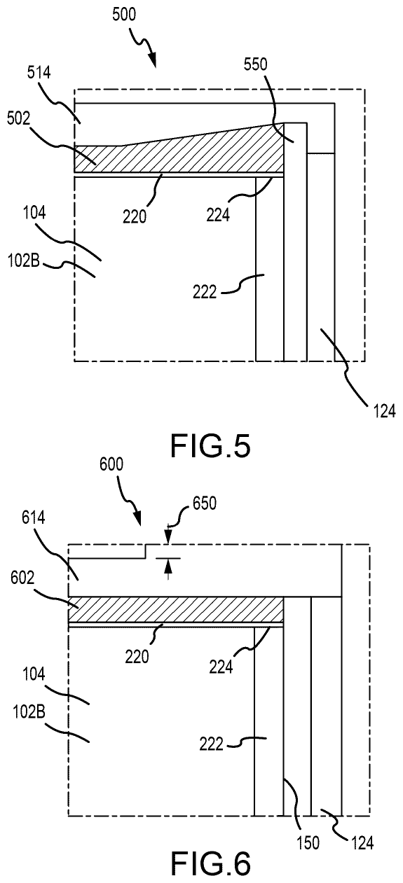

FIG. 5 illustrates a portion of a second exemplary structural battery pack 500. FIG. 5 illustrates a close-up partial cross-sectional view of a corner of a battery pack 500 that may have similar features as battery pack 100 of FIG. 1 with like reference numbers corresponding to like features. Battery pack 500 may be or may include any of the components, features, or characteristics of any of the battery packs described herein. As shown in FIG. 5, battery pack 500 includes a battery cell 104 of a row of battery cells forming a battery stack 102B.

A layer of adhesive 502 can be disposed between the row of battery cells 104 and a cover 514 that fits over the battery cell stack. In the embodiment illustrated in FIG. 5, a thickness of the adhesive 502 (e.g., the adhesive bond line) can be increased in a vicinity of a corner of the battery pack 500, adjacent first lateral wall 124. By increasing the bond line thickness of the layer of adhesive 502 in that particular region, the loads at the peak stress regions of cell cans (e.g., weld joint 224) can be more evenly distributed reducing the peak stress on joint 224. In various embodiments, the cover 514 can include a recess region 550, and/or a deformation (not shown in FIG. 5) that enables an increase in the bond line thickness at the edge of the row of battery cells 104. In some embodiments the recess 550 can extend along all or a portion of a length of first lateral wall 124 and/or may extend along all or a portion of a length of the second lateral wall 126. In some various embodiments recess 550 can be formed in both base 128 (see FIG. 1) and cover and may extend along all or a portion of first and second lateral walls 124, 126, respectively. In further embodiments recess 550 may be formed around an entire perimeter region of cover 514 and/or base (128) such that the recess extends along a length of each of first and second sidewalls and along a length of each of first and second lateral walls.

In some embodiments the bond line thickness may be increased in the same region(s) by deforming the cover 514, as opposed from removing material from the cover as described above. In one example, the cover may include a square or “U-shaped” convex deformation (e.g., channel) that extends away from cells 104 providing for an increase in bond line thickness of adhesive 502. In further embodiments the region at the edge of cells 104 in the region of recess 550 may be filled with a lower modulus adhesive, foam or other pliable material that transfers less stress to the battery cell joint 224 when battery pack 500 is deformed.

FIG. 6 illustrates a portion of a third exemplary structural battery pack 600. FIG. 6 illustrates a close-up partial cross-sectional view of a corner of a battery pack 600 that may have similar features as battery pack 100 of FIG. 1 with like reference numbers corresponding to like features. Battery pack 600 may be or may include any of the components, features, or characteristics of any of the battery packs described herein. As shown in FIG. 6, battery pack 600 includes a battery cell stack 102B including a plurality of battery cells 104. The battery pack 600 can include a cover 614 that fits over the battery cell stack 102B. In various embodiments, the layer of adhesive 602 can be disposed between the battery cell stack 102B and the cover 614. In the embodiment illustrated in FIG. 6, a thickness of the cover 614 can be increased by a distance 650 in a region adjacent front face 150 of battery cell stack 102B and extending to first lateral wall 124. The increased thickness in this region of cover 614 can provide added rigidity in the cover resulting in reduced local deformation and therefore reduced stresses applied to the edge of battery cell stack 102B and weld joint 224 of cell cans. In some embodiments a similar feature may be formed on base 128 (see FIG. 1). In yet further embodiments a similar feature may be formed on base and cover along first and second lateral walls 124, 126 and along first and second sidewalls 110, 112, respectively. Thus, the cover and/or base 128 can carry additional stress protecting the weld joints 224 of each cell 104 of battery cell stack 102B, resulting in improved reliability of the battery pack 600.

In some embodiments distance 650 can be between 0.5 and 10 mm, between 1 and 5 mm or between 2 and 4 mm. In further embodiments distance 650 can be a ratio of a thickness of cover 613 in a thin region. In some embodiments distance 650 can result in between a 5% and a 100% increase in thickness, between a 10% and 70% increase in thickness or between a 20% and 40% increase in thickness.

In some embodiments the localized thickness of the cover 614 can be increased distance 650 by machining, stamping or otherwise forming the cover with the increased thickness regions. In various embodiments the increase in thickness may result from the addition of material, such as, for example, welding, gluing or otherwise securing a strap to the cover along first wall 110, and/or along the second wall and/or along the first and second lateral walls of the battery pack. In some embodiments the strap may be the same material as the cover 614 (e.g., aluminum, steel, graphite composite etc.) while in other embodiments the strap may be a different material than the cover. In various embodiments the strap may be made from, for example, a high-carbon steel or a composite containing, for example, graphite.

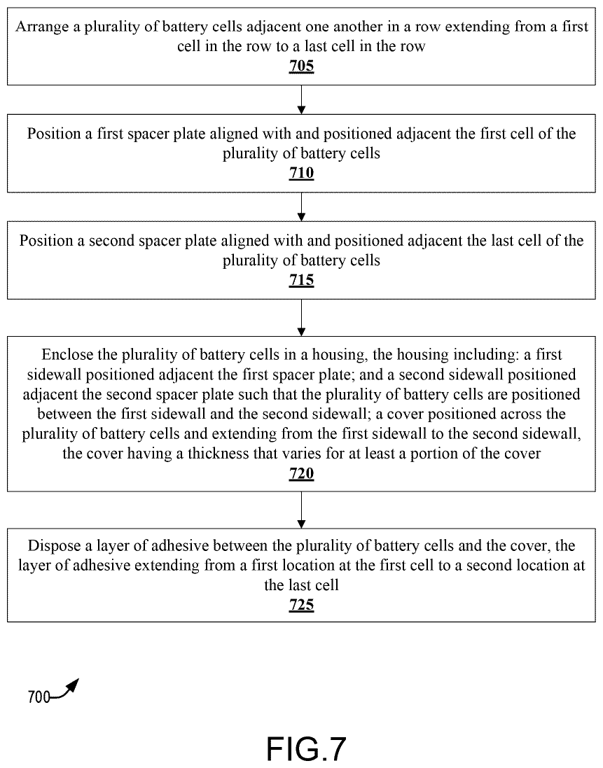

FIG. 7 is a flow chart of a process 700 for forming a battery pack, according to an example of the present disclosure. According to an example, one or more process blocks of FIG. 7 may be performed by one or more machines or via a manufacturing process.

At block 705, process 700 may include arranging a plurality of battery cells adjacent one another in a row extending from a first cell in the row to a last cell in the row. For example, one or more machines or via a manufacturing process may arrange a plurality of battery cells adjacent one another in a row to create a battery cell stack extending from a first cell in the row to a last cell in the row, as described above.

At block 710, process 700 may include positioning a first spacer plate aligned with and positioned adjacent the first cell of the plurality of battery cells. For example, one or more machines or via a manufacturing process may position a first spacer plate aligned with and positioned adjacent the first cell of the plurality of battery cells, as described above.

At block 715, process 700 may include positioning a second spacer plate aligned with and positioned adjacent the last cell of the plurality of battery cells. For example, one or more machines or via a manufacturing process may position a second spacer plate aligned with and positioned adjacent the last cell of the plurality of battery cells, as described above.

At block 720, process 700 may include enclosing the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall, the cover having a thickness that varies for at least a portion of the cover. In some embodiments the cover may have a localized recess machined or formed into the cover, while in various embodiments the cover may have a deformation (e.g., channel) formed into a portion of it and in one embodiment the cover may have a strap that is welded or bonded to it to increase the localized thickness of the cover. For example, the device may enclose the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall, the cover having a thickness that varies for at least a portion of the cover, as described above.

At block 725, process 700 may include disposing a layer of adhesive between the plurality of battery cells and the cover, the layer of adhesive extending from a first location at the first cell to a second location at the last cell. For example, one or more machines or a manufacturing process may dispose a layer of adhesive between the plurality of battery cells and the cover, the layer of adhesive extending from a first location at the first cell to a second location at the last cell, as described above. In some embodiments another layer of adhesive may be disposed between the battery cell stack and a base of the housing.

Process 700 may include additional implementations, such as any single implementation or any combination of implementations described below and/or in connection with one or more other processes described elsewhere herein. In a first implementation, the thickness of the cover is reduced in a first region over the first cell and in a second region over the last cell.

In various embodiments, the thickness of the cover is increased in a first region over the first cell and in a second region over the last cell. In some embodiments, the adhesive may include a thermally conductive adhesive. In various embodiments, process 700 may include isolating the plurality of battery cells from the housing using an electrically insulative, and/or thermally insulative material. In some embodiments, process 700 may include disposing one or more form-in-place foam gaskets on one or more weaker cell weld regions of the plurality of battery cells.

In various embodiments, process 700 further includes forming a stack and the stack of the plurality of battery cells; and bonding at least one of a top or a bottom of the stack to at least one of a cover or a bottom of the housing. In some embodiments, process 700 further includes recessing the layer of adhesive from a front face of the battery cell stack defining a first void in the layer of adhesive extending from the first cell to the last cell. In various embodiments, process 700 further includes disposing another layer of adhesive between the battery cell stack and a base of the housing and forming a recess in the second layer extending from the front face of the battery cell stack. In some embodiments with one or more of the implementations described herein, the plurality of battery cells may include prismatic cells.

It should be noted that while FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

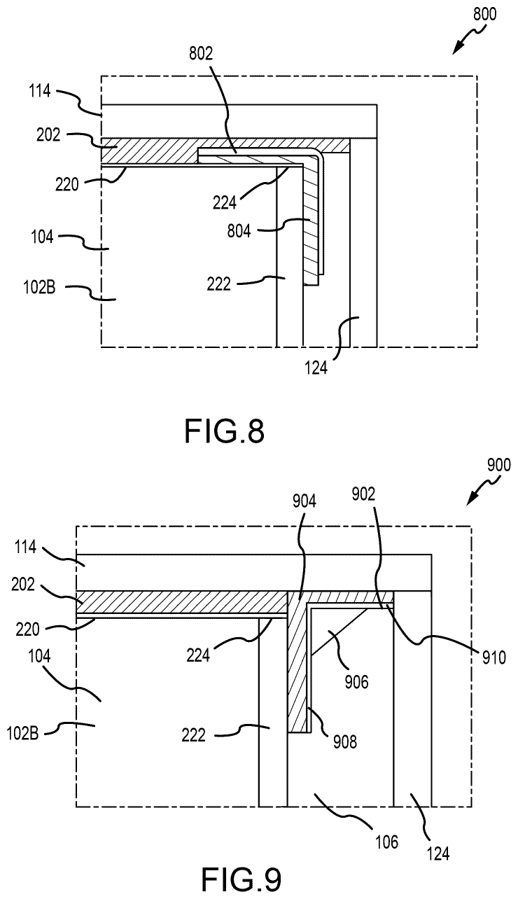

FIG. 8 illustrates a close-up partial cross-sectional view of a corner of a battery pack 800 that may have similar features as battery pack 100 of FIG. 1 with like reference numbers corresponding to like features. Battery pack 800 may be or may include any of the components, features, or characteristics of any of the battery packs described herein. As shown in FIG. 8 battery pack 800 includes a battery cell stack 102B including a plurality of battery cells 104. The battery pack 100 can include a cover 114 that fits over the battery cell stack 102B. A bracket 802 can be attached along a corner of battery stack 102B such that one portion of the bracket is attached to cell enclosure lid 220 and another portion is attached to cell enclosure wall 222, protecting weld joint 224. In various embodiments, the bracket 802 can be L-shaped and can extend along all or a portion of a length of first lateral wall 124 such that the bracket extends across an entire length of battery cell stack 102B. In some embodiments brackets can extend along a length of first lateral wall 124 along the top and bottom of cell stack 102B and along second lateral wall 126 along the top and bottom of the cell stack such that brackets are positioned between the cover and the battery cells and between base 128 (see FIG. 1) and the battery cells. In some embodiments the bracket 802 can protect joint 224 from forces resulting from deformation of the battery pack 800. For example, in some embodiments bracket 802 is made from a metal (e.g., aluminum, steel, etc.) such that forces from a deflection of cover 114 and/or base 128 are applied to bracket 802 which has a relatively high modulus of elasticity to substantially decrease forces imparted to joint 224.

In some embodiments bracket 802 is attached to cell wall 222 and cell lid 220 with an adhesive 804, while in other embodiment the bracket may be welded or attached with fasteners. In various embodiments, a layer of adhesive 202 can be disposed between the battery cells 104 and the cover 114 and may also be disposed between the bracket 802 and the cover.

In some embodiments, the bracket 802 can be the same thickness as a bond line spacer that sets a bond line thickness of adhesive 202, while in other embodiments the bracket may be thinner than a bond line spacer so adhesive 202 and adhesive 804 can be attached to either side of the bracket. In some embodiments, the edges of the bracket 802 can be deburred using a hemming process to remove sharp edges. The bracket 802 can be formed of a metal (e.g., iron, aluminum) or metal alloy (e.g., steel). In various embodiments, the bracket 802 can be formed of a composite material (e.g., fiberglass, or carbon fiber material (e.g., encapsuled carbon fiber material)). In some embodiments a non-electrically conductive bracket 802 can assist with creepage and clearance of the cell edge to the cover 114. In various embodiments, the bracket 802 can be attached to the battery cell 104 using a pressure sensitive adhesive, a thermally conductive adhesive, an electrically insulative adhesive or any other suitable adhesive. In some embodiments one or more brackets 802 can be installed along each edge of each battery stack (e.g., battery stacks 102A and 102B in FIG. 1). In various embodiments, the brackets 802 can be installed in areas where stress concentrations exist and/or where weak regions of battery cells need protection.

FIG. 9 illustrates a close-up partial cross-sectional view of a corner of a battery pack 900 that may have similar features as battery pack 100 of FIG. 1 with like reference numbers corresponding to like features. Battery pack 900 may be or may include any of the components, features, or characteristics of any of the battery packs described herein. As shown in FIG. 9 battery pack 900 includes a battery stack 102B including a plurality of battery cells 104. The battery pack 900 can include a cover 114 that fits over the battery cell stack 102B. As shown in FIG. 9, a bracket 902 can be attached to the cover 114 and cell wall 222 of battery cell 104 enclosure. More specifically, bracket 902 can include a first portion 908 that extends along cell wall 222 and a second portion 910 that extends along cover 114 in a direction opposite cell 104. In some embodiments the bracket 902 can be attached with an adhesive 904, while in other embodiments it can be welded or attached with fasteners. In various embodiments, a layer of adhesive 202 can be disposed between the battery cell stack 102B and the cover 114 and may also be disposed between the bracket 902 and the cover.

In some embodiments, the bracket 902 can be L-shaped and can extend along all or a portion of a length of first lateral wall 124 such that the bracket extends over one or more battery cells 104 in the battery stack 102B (see FIG. 1). In some embodiments a separate bracket can be attached to battery stack 102A (see FIG. 1) and extend along all or a portion of a length of second lateral wall 126 (see FIG. 1). In further embodiments similar brackets may be positioned between the base 128 (see FIG. 1) and the battery cell stacks 102. In some embodiments the bracket 902 can protect battery cell joints 224 from forces resulting from deformation of the battery pack 900. For example, in some embodiments bracket 902 is made from a metal (e.g., aluminum, steel, etc.) such that forces from a deflection of cover 114 are applied to bracket 902 which has a relatively high modulus of elasticity to substantially decrease forces imparted to joint 224. In some embodiments, the bracket 902 can be L-shaped and may include a reinforcement 906 (e.g., gusset) to increase the rigidity of the bracket.

In some embodiments, the edges of the bracket 902 can be deburred using a hemming process to remove sharp edges. The bracket 902 can be formed of a metal (e.g., iron, aluminum) or metal alloy (e.g., steel). In various embodiments, the bracket 902 can be formed of a composite material (e.g., fiberglass, or carbon fiber material (e.g., encapsuled carbon fiber material)). In some embodiments a non-electrically conductive bracket 902 can assist with creepage and clearance of the cell edge to the cover 114 and/or base 128. In various embodiments, the bracket 902 can be attached to the stacks 102 using a pressure sensitive adhesive, a thermally conductive adhesive, an electrically insulative adhesive or any other suitable adhesive. In some embodiments one or more brackets 902 can be installed along each top and bottom outer edge of each battery stack (e.g., battery stacks 102 in FIG. 1). In various embodiments, the brackets 902 can be installed in areas where stress concentrations exist and/or where weak regions of battery cells need protection.

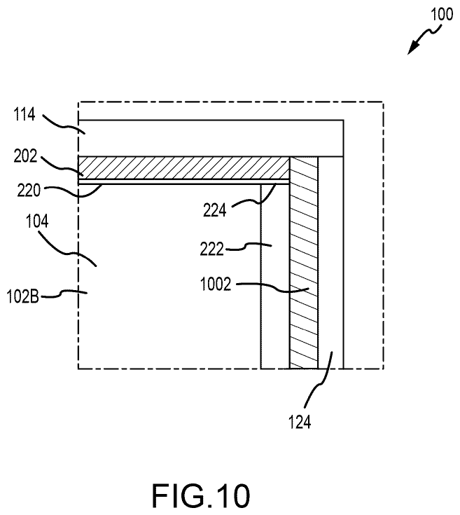

FIG. 10 illustrates a close-up partial cross-sectional view of a corner of a battery pack 1000 that may have similar features as battery pack 100 of FIG. 1 with like reference numbers corresponding to like features. Battery pack 1000 may be or may include any of the components, features, or characteristics of any of the battery packs described herein. As shown in FIG. 10 battery pack 1000 includes a battery cell stack 102B formed from a plurality of battery cells 104. The battery pack 100 can include a cover 114 that fits over the battery cell stack 102B. In various embodiments, a layer of adhesive 202 can be disposed between the battery cell stack 102B and the cover 114. FIG. 10 illustrates a second adhesive layer 1002 that can be disposed between the battery cell stack 102B and the first lateral wall 124. In some embodiments adhesive 1002 can fill an entire gap between first lateral wall 124 and battery cell stack 102B to structurally secure battery cell stack 102B to first lateral wall 124. The additional adhesive layer 1002 can increase overall stiffness of the battery pack. This can reduce the stress applied to the edges of the battery cells including joint 224 and can improve the durability of the structural battery pack 1000. Similarly additional adhesive can be applied between the second lateral wall 126 (see FIG. 1) and battery cell stack 102A. In various embodiments, one or more gaskets can be used to prevent second layer of adhesive 1002 from running down the gap before it is cured.

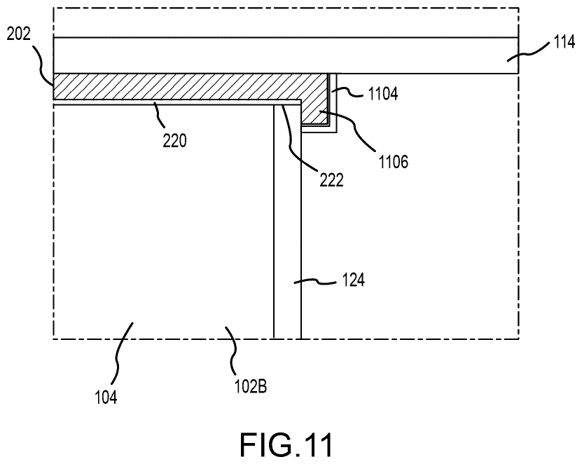

FIG. 11 (see view taken from FIG. 1) illustrates a close-up partial cross-sectional view of an interior face of a battery stack 102B of a battery pack 100 of FIG. 1, with like reference numbers corresponding to like features. As shown in FIG. 11 battery pack 100 includes battery cell stack 102B adjacent a tray 1104 that defines a groove 1106. In some embodiments, the layer of adhesive 202 can be disposed between the battery cell stack 102B and the cover 114 and can be rolled over joint 222 of the battery cell enclosure and into groove 1106. Rolling adhesive 202 over joint 222 may more evenly distribute loads within the battery pack 100 and reduce stresses applied to joint 222. In some embodiments tray 1104 may be attached to an internal face of battery cell stacks 102A and 102B and may be used to separate cell-to-cell electrical connectors, providing protection and electrical isolation.

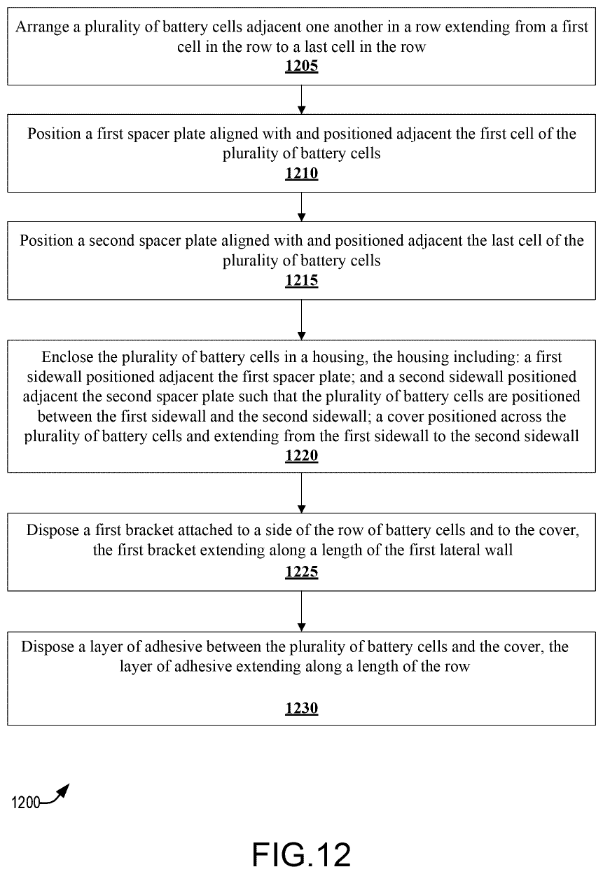

FIG. 12 is a flow chart of a process 1200 for forming a battery pack, according to an example of the present disclosure. According to an example, one or more process blocks of FIG. 12 may be performed by one or more machines or via a manufacturing process.

At block 1205, process 1200 may include arranging a plurality of battery cells adjacent one another in a row extending from a first cell in the row to a last cell in the row. For example, one or more machines or via a manufacturing process may arrange a plurality of battery cells adjacent one another in a row extending from a first cell in the row to a last cell in the row, as described above.

At block 1210, process 1200 may include positioning a first spacer plate aligned with and positioned adjacent the first cell of the plurality of battery cells. For example, one or more machines or via a manufacturing process may position a first spacer plate aligned with and positioned adjacent the first cell of the plurality of battery cells, as described above.

At block 1215, process 1200 may include positioning a second spacer plate aligned with and positioned adjacent the last cell of the plurality of battery cells. For example, one or more machines or via a manufacturing process may position a second spacer plate aligned with and positioned adjacent the last cell of the plurality of battery cells, as described above.

At block 1220, process 1200 may include enclosing the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall. For example, one or more machines or a manufacturing process may enclose the plurality of battery cells in a housing, the housing including: a first sidewall positioned adjacent the first spacer plate; and a second sidewall positioned adjacent the second spacer plate such that the plurality of battery cells are positioned between the first sidewall and the second sidewall; a cover positioned across the plurality of battery cells and extending from the first sidewall to the second sidewall, as described above.

At block 1225, process 1200 may include disposing a first bracket attached to a portion of the first battery cell stack and to the cover, the first bracket extending along a length of the battery cell stack. For example, one or more machines or a manufacturing process may dispose a first bracket attached to a sidewall of each cell in the stack and to the cover, the first bracket extending along a length of the battery cell stack. In further embodiments the first bracket may be attached to a lid of each battery cell and to a sidewall of each battery cell in the stack. The first bracket may be “L-shaped” and may extend along a length of the first lateral wall of the battery pack and along a length of the second lateral wall of the battery pack. In further embodiments one or more brackets may be similarly located and attached a base (see FIG. 1) of housing and attached to one or more regions of the battery cell stack enclosure to increase the rigidity of the battery pack.

At block 1230, process 1200 may include disposing a layer of adhesive between the plurality of battery cells and the cover.

Process 1200 may include disposing a second bracket attached to a bottom of the battery cell stack and to the base, the second bracket extending along a length of the first lateral wall.

Process 1200 may include additional implementations, such as any single implementation or any combination of implementations described below and/or in connection with one or more other processes described elsewhere herein. In a first implementation, the adhesive may include a thermal adhesive.

In various embodiments, process 1200 may include isolating the plurality of battery cells from the housing using insulating material. In some embodiments, process 1200 may include disposing one or more form-in-place foam gaskets disposed on one or more weaker cell weld regions of the plurality of battery cells.

It should be noted that while FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

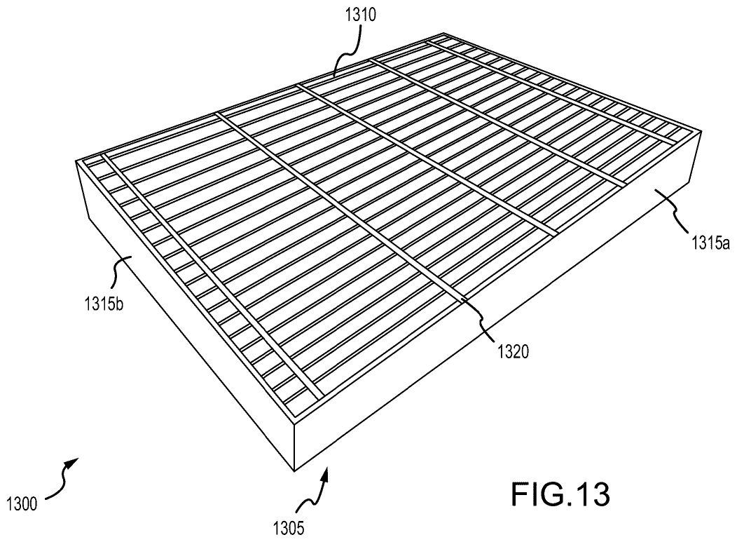

FIG. 13 illustrates a perspective view of a battery pack 1300. Battery pack 1300 may be or may include any of the components, features, or characteristics of any of the battery packs described herein. As shown in FIG. 13 battery pack 1300 includes a housing 1305 that encloses a plurality of battery cells 1310. Housing 1305 includes a cover (not shown in FIG. 13) that may be attached to sidewalls 1315 of housing. An adhesive (not shown in FIG. 13) may be applied to a top surface of plurality of battery cells 1310 and used to bond the cover to the plurality of battery cells to create an integral structure for battery pack 1300. One or more bond line limiters 1320 may be attached to the top surface of plurality of battery cells 1310 to set a bond line thickness of the adhesive such that during production each battery pack has a consistent adhesive bond line thickness.

In various embodiments, it can be desirable to have a bond line thickness of approximately one millimeter for reliability and/or for y-capacitance control. Between a ground, which may also be chassis ground, and either the high voltage positive (HV+) or high voltage negative (HV−), there is a y-capacitance voltage in the system. For noise reduction, it may be desirable for certain HV modules to have a particular capacitance. In some embodiments if the y-capacitance gets too high, it can be a shock hazard. In some embodiments it may be preferable to have the bond lines as thin as possible to reduce the thermal resistance of the battery pack, however as the bond line thickness is reduced the y-capacitance is increased and may exceed the y-capacitance limit. Thus, each battery pack design may have a particular optimal bond line thickness.

The bond line limiters 1320 can be constructed from silicone or other dielectric material. In some embodiments the bond line limiters 1320 can have similar parameters as a cured adhesive so the cells are not exposed to different stresses after the adhesive cures, but the bond line limiters would be stiff enough that the battery stack could not be compressed more than a minimum tolerance.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of these particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

What is claimed is:

1. A battery pack, comprising:
a plurality of battery cells arranged adjacent one another in a row extending from a first cell in the row to a last cell in the row;
a housing enclosing the plurality of battery cells, the housing including:
a first sidewall positioned adjacent the first cell; and
a second sidewall positioned adjacent a second cell such that the plurality of battery cells are positioned between the first sidewall and the second sidewall;
first and second lateral walls extending between the first and second sidewalls;
a cover positioned across the plurality of battery cells and extending from the first sidewall to the second sidewall;
a layer of adhesive disposed between the plurality of battery cells and the cover; and
a bracket having a first portion attached along a top surface of the first cell and along a second portion attached to a wall of the first cell, wherein the bracket extends along a width of the first cell.

2. The battery pack of claim 1 wherein the bracket extends along a width of each of the plurality of battery cells.

3. The battery pack of claim 1, wherein the bracket is positioned parallel to the first lateral wall and extends along at least a portion of a length of the first lateral wall.

4. The battery pack of claim 1, further comprising a base positioned opposite the cover and extending between the first and the second sidewalls.

5. The battery pack of claim 4, wherein each of the plurality of battery cells are attached to the base.

6. The battery pack of claim 1, wherein the bracket is a first bracket and the battery pack comprises a second bracket that is attached along a bottom surface of the first cell and along a portion of the wall of the first cell.

7. The battery pack of claim 1, wherein the bracket is an L-shaped bracket.

8. A battery pack, comprising:
a plurality of battery cells arranged adjacent one another in a row extending from a first cell in the row to a last cell in the row;
a housing enclosing the plurality of battery cells, the housing including:
a first sidewall positioned opposite a second sidewall; and
first and second lateral walls that extend between first and second sidewalls;
a cover positioned across the plurality of battery cells and extending from the first sidewall to the second sidewall and from the first lateral wall to the second lateral wall;
a layer of adhesive disposed between the plurality of battery cells and the cover; and
a bracket attached to the row of battery cells and to the cover.

9. The battery pack of claim 8 wherein the bracket extends along a length of the row of battery cells and is attached to each battery cell of the row of battery cells.

10. The battery pack of claim 8 wherein the bracket has a first portion that is attached to the cover and a second portion that is attached to a wall of each battery cell of the row of battery cells.

11. The battery pack of claim 10, wherein the bracket includes a stiffener extending between the first portion of the bracket and the second portion of the bracket.

12. The battery pack of claim 8, wherein the bracket is a first bracket and the battery pack further comprises a second bracket attached to each cell of the row of battery cells and to a base that is opposite the cover.

13. The battery pack of claim 8, wherein the bracket is an L-shaped bracket.

14. The battery pack of claim 8, wherein the bracket is attached to the first cell and to the cover with an adhesive.

15. A method for forming a battery pack, comprising:
arranging a plurality of battery cells adjacent one another in a row extending from a first cell in the row to a last cell in the row;
enclosing the plurality of battery cells in a housing, the housing including:
a first sidewall positioned opposite a second sidewall;
first and second lateral walls extending between the first and the second sidewalls;
a cover positioned across the plurality of battery cells and extending from the first sidewall to the second sidewall;
attaching a bracket along an edge of the row of battery cells; and
disposing a layer of adhesive between the row of battery cells and the cover.

16. The method of claim 15, wherein the bracket extends along a length of the row of battery cells and is attached to each battery cell of the row of battery cells.

17. The method of claim 15, wherein the bracket has a first portion that is attached to the cover and a second portion that is attached to a wall of each battery cell of the row of battery cells.

18. The method of claim 17, wherein the bracket has a first portion that is attached to the cover and a second portion that is attached to a wall of each battery cell of the row of battery cells.

19. The method of claim 17, wherein the bracket is an L-shaped bracket with the first portion oriented perpendicular to the second portion.

20. The method of claim 15, wherein the housing further comprises a base that is attached to the plurality of battery cells.
